(19) United States
(12) Patent Application Publication
(10) Pub. No.: US 2025/0079781 A1
(43) Pub. Date: Mar. 6, 2025

(54) COMPLIANT PIN ADAPTER PLATE

(71) Applicant: Yazaki North America, Inc., Canton, MI (US)

(72) Inventor: Ryan Michael Bartlett, Plymouth, MI (US)

(21) Appl. No.: 18/282,852

(22) PCT Filed: May 8, 2023
(86) PCT No.: PCT/US2023/021320

§ 371 Date: Sep. 19, 2023

Related U.S. Application Data
(60) Provisional application No. 63/339,872, filed on May 9, 2022.

(51) Int. Cl. H01R 31/06

(52) U.S. Cl. CPC H01R 31/06; H01R 2201/26

(57) ABSTRACT

A connector assembly includes a housing and a terminal assembly received within the housing. The terminal assembly includes an adapter plate and one or more terminals. The adapter plate includes a plurality of slots and is configurable in a first configuration and a second configuration. The one or more terminals are positionable within the plurality of slots of the adapter plate. The one or more terminals include a blade extending from a first side of the adapter plate and one or more pins extending outward from a second side of the adapter plate opposite the first side. The one or more terminals are positionable in a first subset of the plurality of slots to provide the first configuration, and positionable in a second subset of the plurality of slots to provide the second configuration.

### CROSS-REFERENCE TO RELATED PATENT APPLICATION

This application claims the benefit of and priority to U.S. Provisional Patent Application No. 63/339,872, filed May 9, 2022, the entire disclosure of which is incorporated by reference herein.

### BACKGROUND

This application relates generally to wire electrical connector assemblies and more specifically to terminals for installation into a printed circuit board (PCB).

Automobiles may contain a large number of wires for connecting various electrical components. These wires are generally coupled in wire harnesses, which utilize electrical connectors to enable operators to quickly and easily electrically connect the components (e.g., forming wired connections with a male and female connector assembly) during assembly of the automobile. Each component may have a different number of wires that are to be inserted into corresponding cavities in a multi-prong connector or connectors.

### SUMMARY

One exemplary embodiment relates to a connector assembly. The connector assembly includes a housing and a terminal assembly received within the housing. The terminal assembly includes an adapter plate and one or more terminals. The adapter plate includes a plurality of slots and is configurable in a first configuration and a second configuration. The one or more terminals are positionable within the plurality of slots of the adapter plate. The one or more terminals include a blade extending from a first side of the adapter plate and one or more pins extending outward from a second side of the adapter plate opposite the first side. The one or more terminals are positionable in a first subset of the plurality of slots to provide the first configuration, and positionable in a second subset of the plurality of slots to provide the second configuration.

In some embodiments, the adapter plate is configurable in the first configuration and the second configuration based on an electrical loading threshold of the connector assembly.

In some embodiments, the terminal assembly is selectively coupled between a connected position and an unconnected position. The terminal assembly abuts an inner wall of the housing when the terminal assembly is in the connected position.

In some embodiments, the adapter plate is configured to secure the one or more terminals in a rigid orientation to prohibit rotational movement of the one or more terminals within the adapter plate.

In some embodiments, the connector assembly includes a printed circuit board received within the housing opposite the terminal assembly. The printed circuit board includes one or more apertures positioned therein. The one or more pins are coupled to the printed circuit board through the one or more apertures to permit a flow of energy from the blade through the one or more pins to the printed circuit board. The terminal assembly is received within a first side of the housing and the printed circuit board is received within a second side of the housing. The first side is opposite the second side. The one or more pins are spaced apart by a first distance. The one or more apertures are spaced apart by the first distance. The one or more pins and the one or more apertures are aligned along a contact plane.

In some embodiments, the one or more terminals include at least one of a first terminal having a single pin, a second terminal having four pins, or a third terminal having eight pins.

In some embodiments, the one or more slots are arranged in a grid pattern.

Another exemplary embodiment relates to a terminal assembly for a connector assembly. The terminal assembly includes an adapter plate and one or more terminals. The adapter plate includes a plurality of slots and is configurable in a first configuration and a second configuration. The one or more terminals are positionable within the plurality of slots of the adapter plate. The one or more terminals are positionable in a first subset of the plurality of slots to provide the first configuration, and positionable in a second subset of the plurality of slots to provide the second configuration.

In some embodiments, the adapter plate is configured to secure the one or more terminals in a rigid configuration to prohibit rotational movement of the one or more terminals within the adapter plate.

In some embodiments, the connector assembly includes a printed circuit board received within the housing opposite the terminal assembly and including one or more apertures positioned therein. The one or more pins are coupled to the printed circuit board through the one or more apertures to permit a flow of energy from the blade through the one or more pins to the printed circuit board. The one or more apertures are spaced apart at a first distance and the one or more pins are spaced apart at the first distance. The one or more pins and the one or more apertures are aligned along a contact plane.

In some embodiments, the connector assembly includes a blade and one or more pins. The blade extends from a first side of the adapter plate. The one or more pins extend outward from a second side of the adapter plate opposite the first side.

In some embodiments, the terminal assembly is selectively coupled between a connected position and an unconnected position. The terminal assembly abuts an inner wall of a housing when the terminal assembly is in the connected position.

In some embodiments, the adapter plate is configurable in the first configuration and the second configuration based on an electrical loading threshold of the connector assembly.

Another exemplary embodiment relates to a connector assembly. The connector assembly includes a housing, a terminal assembly and a printed circuit board. The terminal assembly is received within the housing. The terminal assembly includes an adapter plate and one or more terminals. The adapter plate is configurable in a first configuration and a second configuration. The one or more terminals are received within the adapter plate. The one or more terminals include a blade extending from a first side of the adapter plate and one or more pins extending outward from a second side of the adapter plate opposite the first side. The printed circuit board is received within the housing opposite the terminal assembly and includes one or more apertures positioned therein. The one or more pins are spaced apart by a first distance. The one or more apertures are spaced apart by the first distance.

In some embodiments, the adapter plate includes one or more slots. The one or more terminals are positioned within the one or more slots. The one or more terminals are positionable in a first subset of the plurality of slots to provide the first configuration, and positionable in a second subset of the plurality of slots to provide the second configuration.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a detailed view of a connector assembly according to an exemplary embodiment.

FIG. 2 is a detailed perspective view of a terminal assembly of the connector assembly of FIG. 1, according to an exemplary embodiment.

FIG. 3 is a detailed view of the terminal assembly being installed within a housing of the connector assembly of FIG. 1, according to an exemplary embodiment.

FIG. 4 is a perspective view of a terminal that is installed into an adapter plate of the connector assembly of FIG. 1, according to an exemplary embodiment.

FIG. 5 is a perspective view of a terminal that is installed into an adapter plate of the connector assembly of FIG. 1, according to an exemplary embodiment.

FIG. 6 is a perspective view of a terminal that is installed into an adapter plate of the connector assembly of FIG. 1, according to an exemplary embodiment.

FIG. 7A-FIG. 7C are views of various examples of adapter plates, according to exemplary embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to a connector assembly may include a housing, a terminal assembly, and a printed circuit board (PCB). The terminal assembly may be received within the housing and includes an adapter plate and one or more terminals, where the one or more terminals are received within the adapter plate. The terminals may include a first end extending outward from a first end of the adapter plate and a second end extending outward form a second end of the adapter plate. The PCB may be received within the housing opposite the terminal assembly and includes one or more apertures positioned therein. The second end of the terminal is coupled to the PCB through the one or more apertures. The one or more apertures are spaced apart at a first distance and the second end of the one or more terminals are spaced apart at a second distance. The first distance is equivalent to the second distance.

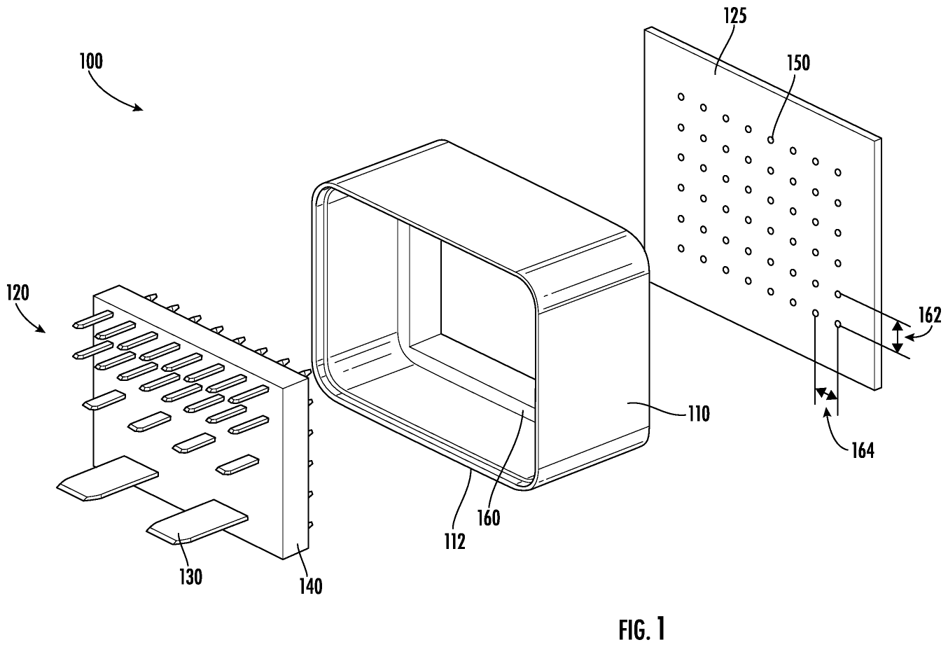

Referring to FIG. 1, a connector assembly 100 is shown according to an exemplary embodiment. The connector assembly 100 may be configured for use in automotive applications, where the connector assembly 100 permits a flow of energy therethrough. In other embodiments, the connector assembly 100 is configured to use in applications other than automotive applications. Although not shown, the connector assembly 100 may include both a male and a female portion, where the male and the female portions couple together to complete a circuit. The connector assembly 100 includes a housing 110. The housing 110 may be configured to hold components of the connector assembly 100 therein. In some embodiments, the housing 110 may hold additional components other than components shown in FIG. 1, such as additional wiring, insulation, or any other components. The housing 110 may have a substantially similar geometry to the components that are positioned within the housing 110. According to an exemplary embodiment, the housing 110 may be a substantially rectangular housing. In other embodiments, the housing 110 may take on any alternate geometrical configuration (e.g., circular, frustoconical, prismatic and/or a combination thereof).

Referring still to FIG. 1, the connector assembly 100 may include a terminal assembly 120. The terminal assembly 120 may be positioned within the housing 110, where the terminal assembly 120 is received through a first end 112 of the housing 110. The terminal assembly 120 may be configured to transfer a flow of energy to, through, or via a printed circuit board (PCB) 125 to a load. In other examples, the terminal assembly 120 may be configured to transfer a flow of energy to one of more electrical connections, where the electrical connections may be electrically coupled to one or more systems (e.g., vehicle systems, etc.). The terminal assembly 120 may include one or more terminals, shown as terminals 130, and an adapter plate 140. The terminals 130 may be fixedly coupled within the adapter plate 140 (e.g., the adapter plate 140 may be at least partially formed around the terminals 130, the terminals 130 may have an interference fit within the adapter plate 140, etc.). In other embodiments, the terminals 130 may be selectively coupled within the adapter plate 140. In such an embodiment, the terminals 130 may have a loose engagement within the adapter plate 140 in which a user may engage or disengage terminals 130 from the adapter plate 140.

The terminal assembly 120 may be selectively coupled between a connected position and an unconnected position. When the terminal assembly 120 is in the connected positon, the terminal assembly 120 may abut an inner wall of the housing 110. Accordingly, when the terminal assembly 120 is in the unconnected positon, the terminal assembly 120 may not abut the inner wall of the housing 110. As will be discussed in greater detail herein, when the terminal assembly 120 is in the connected position, one or more pins (e.g., pins 196) may be received within one or more apertures (e.g., apertures 150) formed within a printed circuit board (e.g., PCB 125).

The terminal assembly 120 may include any configuration of terminals 130. The configuration of terminals 130 within the adapter plate 140 may be based on an electrical loading threshold. The electrical loading threshold may be a maximum loading threshold of the application. In other embodiments, the electrical loading threshold may be a percentage (e.g., 10%, 50%, 60%, 75%, 80%, 90%, etc.) of the electrical loading threshold. For example, the terminal assembly 120 may include a configuration of different size terminals 130 (e.g., maximum load terminals, etc.), each terminal 130 configured to receive a respective gauge wire. In another example, the terminal assembly 120 may include another configuration of different size terminals 130. As can be appreciated, the terminal assembly 120 may include any number of configurations, where each configuration includes a different number, orientation, and/or size of terminals 130.

By way of example, smaller terminals 130 may support lower gauge wires and larger terminals 130 may support higher gauge wires. In other examples, the smaller and larger terminals may include a maximum load threshold, where the wire gauge may be coupled to the terminals 130 accordingly. The terminals 130 may be manufactured out of a conductive material (such as copper, gold, aluminum, etc.), and, as such, transfers the flow of energy therethrough. In other embodiments, the terminals 130 may be manufactured out of any material that can permit the flow of energy therethrough.

The adapter plate 140 may be disposed around the terminals 130 and further insulate the terminals 130 from one another. Furthermore, the adapter plate 140 may be configured to rigidly hold the terminals 130 therein (e.g., prevent rotational movement of the terminals 130, etc.). By way of example, the terminals 130 may protrude from both ends of the adapter plate 140. In other embodiments, the terminals 130 may protrude from one end of the adapter plate 140. In still other embodiments, the terminals 130 may not protrude from the adapter plate 140. As will be discussed in greater detail herein, the terminals 130 and the adapter plate 140 may cooperatively define the terminal assembly 120. When positioned within the housing 110, the adapter plate 140 may be positioned against an inner housing surface 160. The inner housing surface 160 may be positioned along an inner perimeter of the housing 110, and may be a preset distance for the adapter plate 140 to be positioned against.

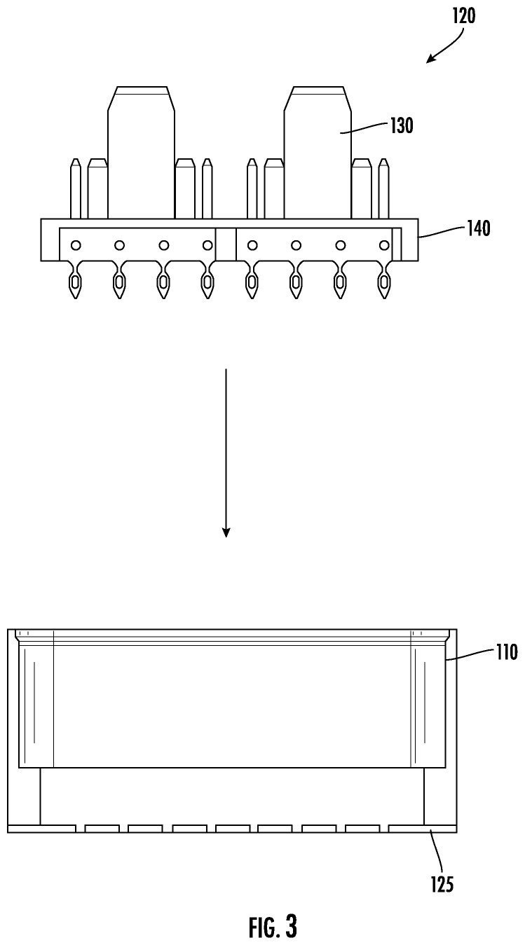

The connector assembly 100 may further include the printed circuit board (PCB) 125. The PCB 125 may be at least partially received within the housing 110, where the PCB 125 may be received through an end opposite the terminal assembly 120. In other embodiments, the PCB 124 may be received through the same end as the terminal assembly 120. The PCB 125 may be configured to receive the terminal assembly 120. More specifically, the PCB 125 includes one or more PCB apertures or slots, shown as apertures 150, where the apertures 150 are configured to receive the terminals 130. That is, the terminals 130 may be configured to receive a pin (e.g., pin 196 in FIG. 4). As shown in FIG. 3, in cooperation with PCB 125 in FIG. 1, a wire connection may be coupled to (e.g., via solder, a fastener, etc.) the terminals 130 to permit a flow of electrical energy from the terminals 130 to the PCB 125. Accordingly, the electrical energy will also flow from the PCB 125 to the respective vehicle system. As can be appreciated, the connector assembly described herein may used in other applications other than vehicle systems (e.g., industrial applications, home applications, individual component applications, etc.). The apertures 150 may be arranged in a similar grid pattern as the one or more cavities of the adapter plate 140. As such, each of the apertures 150 may be aligned with each of the one or more cavities such that each aperture defines a respective alignment axis where each of the one or more cavities are aligned along.

The PCB 125 may include one or more layers of both insulating and conducting materials to provide controlled electrical connections for the terminals 130. In other embodiments, the PCB 125 may include one layer of the insulating or the conducting material. The PCB 125 may include an aperture distance, shown as first distance 162 and second distance 164. The first distance 162 and the second distance 164 may define both a vertical and horizontal distance between the apertures 150. By way of example, the first distance 162 may be equal or substantially equivalent to the second distance 164, thus the PCB 125 may include a substantially uniform aperture construction. In other embodiments, the first distance 162 may be substantially different to the second distance 164.

According to an exemplary embodiment, the first distance 162 and the second distance 164 may be 6.3 millimeters. In other embodiments, the first distance 162 and the second distance 164 may be more or less than 6.3 millimeters. Additionally or alternatively, an aperture size and pitch of the apertures 150 remains consistent through any PCB 125 such to create a universal PCB 125. Although the PCB 125 is shown as being an eight-by-five aperture configuration, the PCB 125 may include any configuration that would be sufficient for the application (e.g., four-by-six, seven-by-seven, etc.).

Although the connector assembly 100 is shown as a male end connector, the same configuration and system described herein may be utilized within a female end connector. In such an example, the female connector may include one or more apertures configured to secure terminals of the male connector.

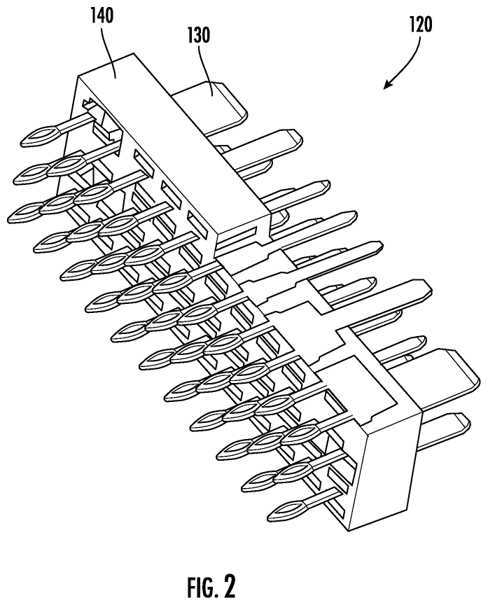

Referring now to FIG. 2, a perspective view of the terminal assembly 120 is shown. As shown, the terminals 130 may be at least partially received within the adapter plate 140 where the respective terminals 130 may include more than one pin (e.g., pin 196 in FIG. 4). The adapter plate 140 may include one or more cavities (e.g., slots, etc.). The cavities may be positioned within the adapter plate 140, where terminals 130 may be positioned within. That is, the terminals 130 may be inserted into the cavities and then may be coupled within via manufacturing processes (e.g., stitching, stamping, molding, etc.). The one or more cavities may be arranged in a grid pattern. That is, the one or more cavities may be arranged along substantially horizontal and vertical planes where the one or more cavities define the grid pattern. In other embodiments, the one or more cavities may define an alternate structure or may be arranged in a non-uniform configuration. By way of example, a number of cavities may not need to be equivalent to a number of terminals 130. For example, some applications may require a small amount of energy, such that there may only be a small number and/or size of terminals 130 positioned within the adapter plate 140. In another example, some applications may require a large amount of energy, such that there may be a large number and/or size of terminals 130 positioned within the adapter plate 140. According to an exemplary embodiment, the terminal assembly 120 may be customizable for a specific application, where the number and/or size of the terminals 130 is matched for the application.

The adapter plate 140 may be further configured to hold the terminals 130 in a specific orientation. For example, the adapter plate 140 may be configured to hold the terminals 130 in a proper orientation (e.g., pitch, etc.) to ensure a proper assembly between the terminals 130 and the PCB 125.

Referring now to FIG. 3, a cross-section view of the terminal assembly 120 being installed into the housing 110 is shown. The terminal assembly 120 may be inserted into the housing 110 after the terminals 130 have been assembled into the adapter plate 140. In other embodiments, the adapter plate 140 may be first inserted into the housing 110 then the terminals are inserted into the adapter plate 140. In still other embodiments, the terminals 130 may be first inserted into the housing 110 and then the adapter plate 140 may be inserted around and within the terminals 130. As shown in FIG. 3, the PCB 125 may abut an end of the housing 110, opposite the terminal assembly 120, where the terminal assembly 120 is inserted into the housing 110 and further couples to the PCB 125.

To assemble the connector assembly 100, the terminal assembly 120 may first be assembled. The terminal assembly 120 may include a desired and/or needed amount and/or configuration of terminals 130. The PCB 125 may then be received by the housing 110, at one end of the housing 110. Then, the terminal assembly 120 may be inserted into the housing 110 at another end of the housing 110, where the terminals 130 are coupled to the apertures 150. In another embodiment, the connector assembly 100 may not need an adapter plate 140. In such an embodiment, the terminals 130 may be directly coupled (e.g., stitched, etc.) to the PCB 125.

Referring generally to FIGS. 4-6, perspective views of various configurations of terminals 130 are shown. The terminals 130 may include a blade 192 and a pin 196, where the pin 196 is positioned opposite the blade 192. In some embodiments, the pin 196 may be positioned proximate the blade 192. The blade 192 may maintain USCAR connector mating standards between male and female connectors. The terminals 130 may further include a middle portion 194 positioned between the blade 192 and the pin 196. The middle portion 194 may be defined as a busbar, where a flow of energy may flow therethrough. Both the blade 192 and the pin 196 may extend from the middle portion 194. According to an exemplary embodiment, the portions 192, 194, 196 may cooperatively define the terminal 130.

Referring specifically to FIG. 4, a terminal 130a is shown as having a single pin 196, according to an exemplary embodiment. As can be appreciated, the terminal 130a may be coupled to the adapter plate 140 at any location. For example, in stances where the adapter plate 140 does not have cavities for terminals 130 having multiple pins, the terminal 130a may be installed to provide an electrical connection. In some embodiments, the adapter plate 140 may only include single pin terminals 130a.

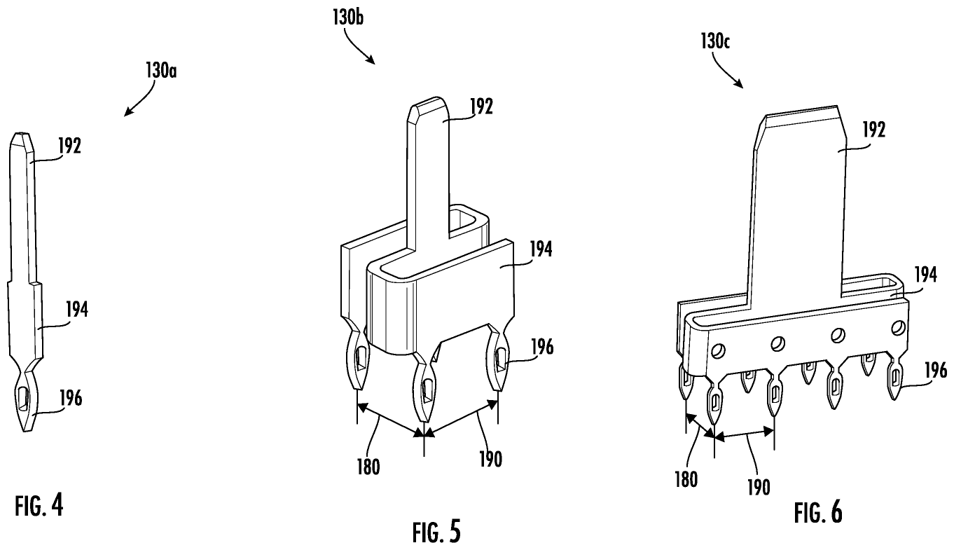

Referring to FIGS. 5 and 6, the terminal 130 is shown as having multiple pins 196, shown as terminal 130a and terminal 130b, according to an exemplary embodiment. Specifically, FIG. 5 shows the terminal 130a having four pins 196 and FIG. 6 shows the terminal 130b having six pins 196. The terminals 130a, 130b may include a substantially similar profile as the terminal 130 shown in FIG. 4. The terminal 130 may include multiple pins 196 (e.g., pins, etc.) extending from the middle portion 194. The terminals 130b, 130c may include any number of pins 196. That is, the terminals 130b, 130c may include any number of pins 196 that support the blade 192, where the number of pins 196 may not exceed an amount of apertures 150. The pins 196 may be spaced apart from one another. More specifically, the pins 196 may be spaced apart by a third distance 180 and a fourth distance 190. The third distance 180 may be equal or substantially equal to the fourth distance 190. In other embodiments, the third distance 180 may be substantially different to the fourth distance. As can be appreciated, the first distance 162, second distance 164, third distance 180 and fourth distance 190 may be substantially similar to one another, where installing the terminal assembly 120 into the PCB 125 ensures a proper connection. For example, the terminal assembly 120 may be oriented in any direction, but as long as the terminal assembly 120 remains substantially parallel to the PCB 125 during assembly, the pins 196 will almost always engage the apertures 150.

The adapter plate 140 may include any combination of terminals 130a, 130b, 130c that aligns the pins 196 with the apertures 150. For example, each of the apertures 150 may be spaced apart by the distance substantially equivalent to the distance between the pins 196 to permit engagement of the pins 196 within the PCB 125. Additionally or alternatively, each pin 196 may defines a pin axis. Each pin axis, when the adapter plate 140 is assembled, may extend through a respective aperture 150. Although the terminal assembly 120 has been shown using the same PCB 125, it can be appreciated, that the PCB 125 may be manufactured for a specific application. Accordingly, the PCB 125 may have any geometrical configuration that can be designed for the specific application. In such an example, the adapter plate 140 may include any number and/or combination of terminals 130a, 130b, 130c within the geometrical configuration of the PCB 125

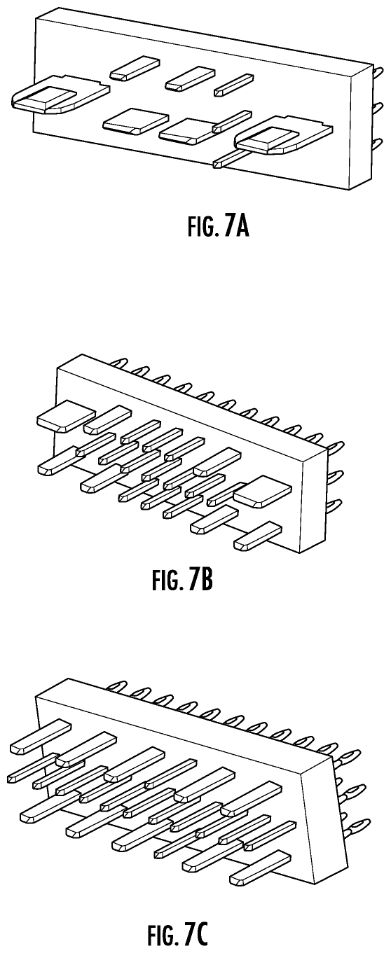

According to an exemplary embodiment, the terminal assembly 120 may include any combination of terminals 130a, 130b, 130c to form the terminal assembly 120. That is, the adapter plate 140 may include any combination and/or orientation of terminals 130a, 130b, 130c such that the adapter plate 140 may be defined as a universal adapter plate. In other embodiments, the terminal assembly 120 may include any combination of terminals other than terminals 130a, 130b, 130c. For example, and referring to FIG. 7A-FIG. 7C, the terminal assembly 120 may have various different combinations of terminals 130a, 130b, 130c, depending on a particular application or design need. However, according to the systems and methods described herein, the adapter plates 140 may be configurable relatively simply to accommodate different design needs without having to mass-produce each separately designed connectors.

By way of example, the terminal assembly 120 may have any combination of terminals 130a, 130b, 130c for a specific application (e.g., based on an output threshold, etc.). The number and/or size of terminals 130a, 130b, 130c may be substantially equivalent to a number and/or size of apertures within the female connector. As can be appreciated, the terminal assembly 120 may be manufactured on a design criteria from the female connector. In one example, the terminal assembly 120 may include a small number of terminals 130a, 130b, 130c. In another example, the terminal assembly 120 may include a large number of terminals 130a, 130b, 130c. In yet another example, the terminal assembly 120 may include any combination of the terminals 130a, 130b, 130c to satisfy the output threshold of the female connector in an arrangement substantially similar to the geometrical configuration of the PCB 125.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the connector assembly as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A connector assembly, comprising:
a housing; and
a terminal assembly received within the housing, the terminal assembly comprising:
an adapter plate comprising a plurality of slots, the adapter plate configurable in a first configuration and a second configuration;
one or more terminals positionable within the plurality of slots of the adapter plate, the one or more terminals comprising:
a blade extending from a first side of the adapter plate; and
one or more pins extending outward from a second side of the adapter plate opposite the first side;
wherein the one or more terminals positionable in a first subset of the plurality of slots to provide the first configuration, and positionable in a second subset of the plurality of slots to provide the second configuration.

2. The connector assembly of claim 1, wherein the adapter plate is configurable in the first configuration and the second configuration based on an electrical loading threshold of the connector assembly.

3. The connector assembly of claim 1, wherein the terminal assembly is selectively coupled between a connected position and an unconnected position, and wherein the terminal assembly abuts an inner wall of the housing when the terminal assembly is in the connected position.

4. The connector assembly of claim 1, wherein the adapter plate is configured to secure the one or more terminals in a rigid orientation to prohibit rotational movement of the one or more terminals within the adapter plate.

5. The connector assembly of claim 1, further comprising a printed circuit board received within the housing opposite the terminal assembly and comprising one or more apertures positioned therein;
wherein the one or more pins are coupled to the printed circuit board through the one or more apertures to permit a flow of energy from the blade through the one or more pins to the printed circuit board.

6. The connector assembly of claim 5, wherein the terminal assembly is received within a first side of the housing and the printed circuit board is received within a second side of the housing, the first side opposite the second side.

7. The connector assembly of claim 5, wherein the one or more pins are spaced apart by a first distance, and wherein the one or more apertures are spaced apart by the first distance.

8. The connector assembly of claim 5, wherein the one or more pins and the one or more apertures are aligned along a contact plane.

9. The connector assembly of claim 1, wherein the one or more terminals comprises at least one of a first terminal having a single pin, a second terminal having four pins, or a third terminal having eight pins.

10. The connector assembly of claim 1, wherein the one or more slots are arranged in a grid pattern.

11. A terminal assembly for a connector assembly, comprising:
an adapter plate comprising a plurality of slots, the adapter plate configurable in a first configuration and a second configuration; and
one or more terminals positionable within the plurality of slots of the adapter plate;
wherein the one or more terminals are positionable in a first subset of the plurality of slots to provide the first configuration, and positionable in a second subset of the plurality of slots to provide the second configuration.

12. The terminal assembly of claim 11, wherein the adapter plate is configured to secure the one or more terminals in a rigid orientation to prohibit rotational movement of the one or more terminals within the adapter plate.

13. The terminal assembly of claim 11, wherein the connector assembly comprises a printed circuit board received within the housing opposite the terminal assembly and comprising one or more apertures positioned therein;
wherein the one or more pins are coupled to the printed circuit board through the one or more apertures to permit a flow of energy from the blade through the one or more pins to the printed circuit board.

14. The terminal assembly of claim 13, wherein the one or more apertures are spaced apart at a first distance and the one or more pins are spaced apart at the first distance.

15. The terminal assembly of claim 13, wherein the one or more pins and the one or more apertures are aligned along a contact plane.

16. The terminal assembly of claim 11, further comprising:
a blade extending from a first side of the adapter plate; and
one or more pins extending outward from a second side of the adapter plate opposite the first side.

17. The terminal assembly of claim 11, wherein the terminal assembly is selectively coupled between a connected position and an unconnected position, and wherein the terminal assembly abuts an inner wall of a housing when the terminal assembly is in the connected position.

18. The terminal assembly of claim 11, wherein the adapter plate is configurable in the first configuration and the second configuration based on an electrical loading threshold of the connector assembly.

19. A connector assembly, comprising:
a housing;
a terminal assembly received within the housing, the terminal assembly comprising:
an adapter plate configurable in a first configuration and a second configuration; and
one or more terminals received within the adapter plate, the one or more terminals comprising:
a blade extending from a first side of the adapter plate; and
one or more pins extending outward from a second side of the adapter plate opposite the first side; and
a printed circuit board received within the housing opposite the terminal assembly and comprising one or more apertures positioned therein;
wherein the one or more pins are spaced apart by a first distance, and wherein the one or more apertures are spaced apart by the first distance.

20. The connector assembly of claim 19, wherein the adapter plate comprises one or more slots, the one or more terminals positionable within the one or more slots, and wherein the one or more terminals positionable in a first subset of the plurality of slots to provide the first configuration, and positionable in a second subset of the plurality of slots to provide the second configuration.
